(19) United States
(12) Patent Application Publication
(10) Pub. No.: US 2006/0274791 A1
(43) Pub. Date: Dec. 7, 2006

(54) Method measuring a delay time metric and measurement system

(76) Inventors: Francisco Javier Garcia, Dunfermline (GB); Robert Gardner, Glasgow (GB)

Correspondence Address: PERMAN & GREEN, 425 POST ROAD, FAIRFIELD, CT, 06824, US

(21) Appl. No.: 11/400,329

(22) Filed: Apr. 7, 2006

(30) Foreign Application Priority Data
Jun. 1, 2005 (GB) 0511113.3

(51) Int. Cl. H04J 3/06

(52) U.S. Cl. 370/508

(57) ABSTRACT

In a method of measuring a delay time metric in relation to a round-trip path in a communications network, a protocol data unit is generated in accordance with a data structure definition of a communications protocol supporting an extendible schema, the protocol data unit comprising an opaque object conforming to the extendible schema. The protocol data unit is provided with a routing address corresponding to a source node to cause the protocol data unit, when sent, to follow the round-trip path from the source node back to the source node via a destination node. The protocol data unit is sent from the source node to the destination node, received at the destination node, and forwarded from the destination node to the routing address. Measurement data is recorded in the opaque object in respect of at least one network node on the round-trip path, and at least part of the measurement data contained in the opaque object is used to calculate the delay time metric.

The present invention relates to a method of measuring a delay time metric of the type, for example, that generates a protocol data unit to provide a measure of network performance. The present invention also relates to a measurement system for a communications system of the type, for example, used to measure network performance.

### BACKGROUND ART

In the field of communications networks, it is necessary to monitor and optimise operation of the communications networks. In this respect, as the communications networks grow, for example the Internet, the need to monitor and optimise only increases. One example of monitoring communications networks is the performance of so-called round-trip time measurements.

One known Service Assurance technology for measuring round-trip times is known as Active Measurement Technology, and involves the generation, transmission and capture of well-formed synthetic traffic within a packet-switched network.

The round-trip time of a packet from a source node to a destination node, measured using the above technology, is useful for several reasons. Firstly, some applications do not perform well, or at all, if a so-called end-to-end delay between nodes is large relative to a threshold value. When round-trip times are too large, some transport-layer protocols are less able to sustain high bandwidth. The threshold value for round-trip time provides an estimate of the propagation and transmission delay along a path in a communications network, or of a likely delay under lightly-loaded path conditions. Round-trip times above the threshold provide a good indication of the level of congestion present in a path followed by packets. Large values of round-trip time can affect the performance of some applications; excessive delay variation titter) can disrupt real-time applications.

Round-trip time measurements are advantageous over one-way delay measurements due to their ease of deployment; round-trip time measurement requires a lower additional functionality overhead at a destination point as compared with the functionality required to carry out one-way delay measurement, for example clock synchronisation. Also, round-trip time measurements sometimes provide ease of interpretation, since the round-trip time is, in fact, the quantity of interest in some circumstances; it is less accurate to deduce the round-trip time from matching one-way delays.

The primary round-trip measurement solution for use in relation to Internet Protocol (IP) version 6 (IPv6) traffic is the so-called Internet Control Message Protocol version 6 (ICMPv6) echo request/response protocol as described in Request For Comments (RFC) 2463 (www.faqs.org).

In this protocol, ICMPv6 echo request packets, with zero or more octets of arbitrary data, are sent by the source node. When the packet arrives at the destination node, a corresponding echo response packet is immediately “reflected” back to the source node in accordance with the ICMPv6. A time between sending the echo request packet and receiving the echo response packet provides a measure of the round-trip time.

This is the basis of a so-called “ping6” application, a well-known IPv6 round-trip time measurement application that uses 64 byte ICMPv6 echo request/reply packets. However, sometimes a router handles ICMPv6 request packets differently to regular user traffic and so a round-trip time measure subsequently obtained is not indicative of the delay as would be experienced by other upper-layer protocols, i.e. above a Network layer, for example User Datagram Protocol (UDP) or Transmission Control Protocol (TCP). Thus, it is not possible to obtain a reliable measure for the round-trip time of an IPv6 datagram with an arbitrary payload type and length using the ICMPv6 echo/response mechanism.

However, the “ping6” application has other disadvantages. Since an Internet path from a source node to a destination node can differ from the path from the destination node back to the source node, known as the asymmetric path problem, a measure of round-trip times using the “ping6” application is not reliable. Even when the outward bound and return paths are symmetric, asymmetric queuing characteristics can exist. Additionally, performance of an application can sometimes depend mostly on performance along a path in one direction. Also, in quality-of-service (QoS) enabled networks, provisioning in one path direction may be radically different to provisioning in a reverse direction, and thus the QoS guarantees in one direction differs from those in the other direction.

Furthermore, for known round-trip time calculation techniques, it is customary for the source node to maintain state information, i.e. timestamp and packet identification information, for each sent packet in order to be able to calculate the round-trip time upon receipt of a matching response packet. Although the appropriate information, in particular the timestamp, could be sent as part of the arbitrary data field of the ICMPv6 echo request/response packets, it would not be possible to do likewise with an arbitrary protocol/payload type and length, even if such packets could be reflected by the destination node

### DISCLOSURE OF INVENTION

According to a first aspect of the present invention, there is provided a method of measuring a delay time metric in relation to a round-trip path in a communications network, the method comprising: generating a protocol data unit in accordance with a data structure definition of a communications protocol supporting an extendible schema, the protocol data unit comprising an opaque object conforming to the extendible schema; providing the protocol data unit with a routing address corresponding to a source node to cause the protocol data unit, once sent, to follow the round-trip path from the source node back to the source node via a destination node; sending the protocol data unit from the source node to the destination node; receiving the protocol data unit at the destination node; forwarding the protocol data unit from the destination node to the routing address; wherein measurement data is recorded in the opaque object in respect of at least one network node on the round-trip path; and format least one of the measurement data contained in the opaque object is used to calculate the delay time metric.

The at least one network node may comprise the source node, the delay time metric being a round-trip time metric.

The measurement data may comprise: first measurement data indicative of a time of departure of the protocol data unit from the source node.

The delay time metric may be calculated from the measurement data contained in the opaque object and second measurement data indicative of a time of receipt of the protocol data unit by the source node.

The measurement data may comprise: second measurement data indicative of a time of receipt of the protocol data unit by the source node.

The method may further comprise: providing the protocol data unit with at least one further routing address in addition to the routing address provided prior to sending the protocol data unit to the destination node.

The routing address may be a final routing address.

The method may further comprise: generating third measurement data at the destination node, the third measurement data being indicative of a time of receipt of the protocol data unit at the destination node; and supplementing the opaque object with the third measurement data.

The method may further comprise: generating fourth measurement data at the destination node, the fourth measurement data being indicative of a time of transmitting the protocol data unit from the destination node; and supplementing the opaque object with the fourth measurement data.

The measurement data may comprise the third measurement data. The measurement data may comprise the fourth measurement data.

The at least one further routing address may correspond to an intermediate node; and the method may further comprise: receiving the protocol data unit at the intermediate node; generating fifth measurement data indicative of a time of receipt of the protocol data unit at the intermediate node; and supplementing the opaque object with the fifth measurement data.

The at least one further routing address may correspond to an intermediate node; and the method may further comprises: receiving the protocol data unit at the intermediate node; generating sixth measurement data indicative of a time of transmitting the protocol data unit from the intermediate node; and supplementing the opaque object with the sixth measurement data.

The measurement data may comprise the fifth measurement data. The measurement data may comprise the sixth measurement data.

The method may further comprise: setting a traffic class field of the protocol data unit. Alternatively, or additionally, the method may comprise: setting a flow label field of the protocol data unit.

The opaque object may be an extension header. The extension header may be a Destination Options Header. The protocol data unit may be a IPv6 packet.

The measurement data may be timestamp data.

According to a second aspect of the present invention, there is provided a computer program code element comprising computer program code means to make a computer execute the method as set forth above in relation to the first aspect of the invention.

The computer program code element may be embodied on a computer readable medium.

According to a third aspect of the present invention, there is provided a network node apparatus for generating a monitoring protocol data unit, the apparatus comprising: a processing resource arranged to generate, when in use, a protocol data unit in accordance with a data structure definition of a communications protocol supporting an extendible schema, the protocol data unit comprising an opaque object conforming to the extendible schema; wherein the protocol data unit comprises a routing address corresponding to the network node apparatus for causing the protocol data unit, when sent, to follow a round-trip path from the network node back to the network node via a destination node; and the processing resource is further arranged to send, when in use, the protocol data unit from the network node to the destination node, the opaque object comprising first measurement data indicative of a departure time of the protocol data unit from the network node.

The processing resource may be arranged to generate, when in use, second measurement data in response to receipt of the protocol data unit by the network node, and using the first and second measurement data to calculate a round-trip time metric.

According to a fourth aspect of the present invention, there is provided a measurement system for a communications network, the system comprising: a source node arranged to generate, when in use, a protocol data unit in accordance with a data structure definition of a communications protocol supporting an extendible schema, the protocol data unit comprising an opaque object conforming to the extendible schema, and including a routing address corresponding to the source node to cause the protocol data unit, when sent, to follow a round-trip path from the source node back to the source node; a destination node arranged to receive, when in use, the protocol data unit sent, when in use, from the source node, the destination node being further arranged to forward, when in use, the protocol data unit to the routing address; wherein measurement data is recorded in the opaque object in respect of at least one network node on the round-trip path; and at least part of the measurement data contained in the opaque object is used to calculate a delay time metric.

According to a fifth aspect of the present invention, there is provided a use of a protocol data unit to follow a round-trip path and collect measurement data from at least one node on the round-trip path, the protocol data unit having been formed in accordance with a data structure definition of a communications protocol supporting an extendible schema, the protocol data unit comprising an opaque object conforming to the extendible schema and the opaque object comprising the measurement data.

It is thus possible to provide a method of measuring a delay time metric and a system that can be used to calculate a round-trip time measurement without a number of the disadvantages of existing techniques. In this respect, unlike the “ping6” application, the method, system and apparatus described herein is independent of higher layer protocols used. Consequently, similar measurements can therefore be carried out for any chosen upper-layer protocol, i.e. above the Network layer of a protocol stack to reflect the experience of real user data more accurately than by existing measurement techniques. Additionally, the method, system and apparatus can be implemented for any size of protocol data unit payload up to a minimum of the Maximum Transit Units (MTUs) for respective segments of a path from source node to destination node and back to the source node. This also therefore permits the experience of the real user data to be accurately reflected. Further, the method, system and apparatus can be implemented as a stateless process, since the measurement data associated with each measurement of, for example, a round-trip time can be carried in-line with the protocol data unit itself. Thus, this technique is appropriate to any upper layer protocol.

Another advantage of the method, system and apparatus described herein is the possibility of being able to measure a round-trip time from the source node to one or more intermediate points before return of the protocol data unit to the source node. For example, it is possible to measure the total delay from a source node ‘A’, to an intermediate node ‘B’, to an intermediate node ‘C’, and then back to the source node ‘A’. Also, by additional instrumenting of the destination node with appropriate measurement functionality as set forth herein, the method and system described herein permits separate measurement of end-to-end delays associated with an Internet path from the source node to the destination node and from the destination node back to the source node.

Furthermore, it is possible to make separate measurements of end-to-end delays between consecutive routing points as specified in the initial IPv6 header and routing header of the protocol data unit, as well as or alternatively make separate measurements of end-to-end delays associated with additional Internet paths between intermediate nodes before the protocol data unit returns to the source node. For example, it is possible to measure individual delays between the source node ‘A’, the intermediate node ‘B’, the intermediate node ‘C’, and back to the source node ‘A’.

Additionally, by setting traffic class or flow label fields of an IPv6 (active) measurement packet, it is thus possible to obtain round-trip time measurements associated with differentiated classes of service that might be offered by an operator or service provider in a communications network.

### BRIEF DESCRIPTION OF DRAWINGS

At least one embodiment of the invention will now be described, by way of example only, with reference to the accompanying drawings, in which:

FIG. 1 is a schematic diagram of part of a communications network;

FIG. 2 is a schematic diagram of a processing resource of a source node constituting an embodiment of the invention;

FIG. 3 is a flow diagram of a first part of a method employed by the processing resource of FIG. 2;

FIG. 4 is a schematic diagram of a first structure of a packet formed in the method of FIG. 3;

FIG. 5 is a flow diagram of a second part to the first part of the method of FIG. 4;

FIG. 6 is a schematic diagram of a second structure of a packet used in a second embodiment of the invention;

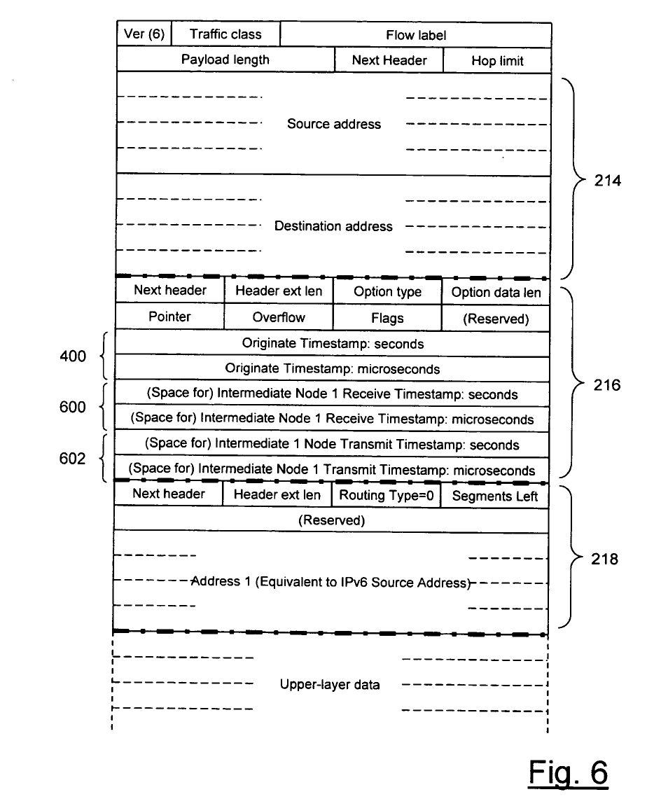

FIG. 7 is a schematic diagram of a third structure of a packet used in a third embodiment of the invention;

FIG. 8 is a flow diagram of an alternative second part to the first part of the method of FIG. 4 and constituting a fourth embodiment of the invention; and

FIG. 9 is a schematic diagram of a fourth structure of a packet formed in the alternative second part of the method of FIG. 8.

### DETAILED DESCRIPTION

Throughout the following description identical reference numerals will be used to identify like parts.

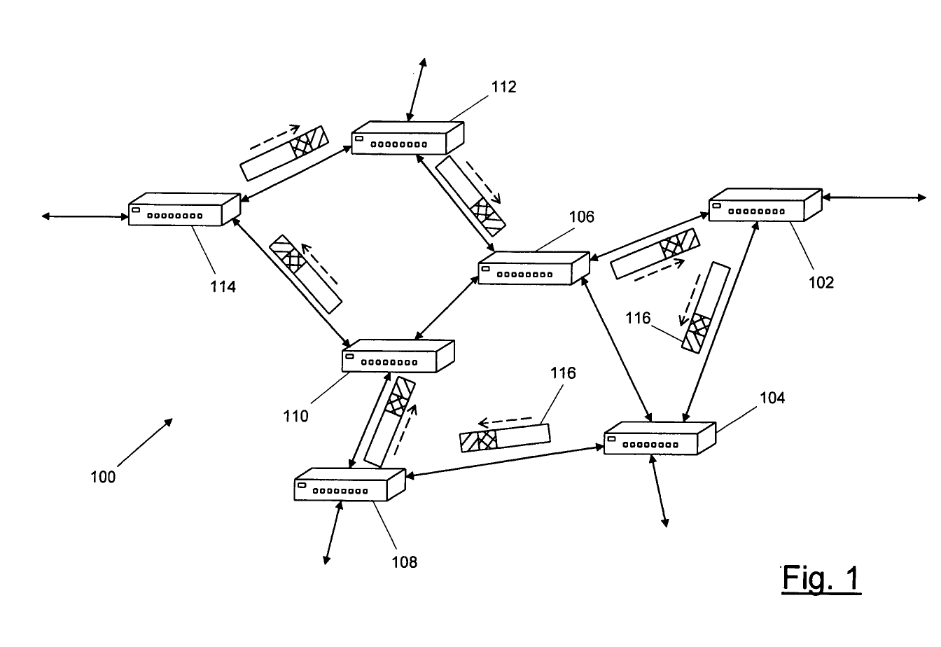

Referring to FIG. 1, a part of a communications network 100, for example the Internet, comprises a source node 102 coupled to a first intermediate node 104 and a second intermediate node 106. The communications network 100 is an Internet Protocol (IP) network, in particular an IPv6 network.

The first intermediate node 104 is coupled to a third intermediate node 108 as well as the second intermediate node 106. Both the second intermediate node 106 and the third intermediate node 108 are coupled to a fourth intermediate node 110, the second intermediate node 106 also being coupled to a fifth intermediate node 112. Both the fourth and fifth intermediate nodes 110, 112 are coupled to a destination node 114.

Although reference is made herein to “nodes”, the skilled person will appreciate that the nodes can be hosts or routers, or other network elements, dependent upon the functionality required of the network element at a particular location of the network element in the communications network 100. In this respect, the network element has to be capable of carrying out the functionality described herein in relation to embodiments of the invention in addition to supporting the IPv6 protocol.

In this example, the operation of the source node 102 is modified to perform certain tasks as are described herein. In contrast, the destination node 114 is not, in this example, modified and is a router that performs the normal routing functionality expected of a router.

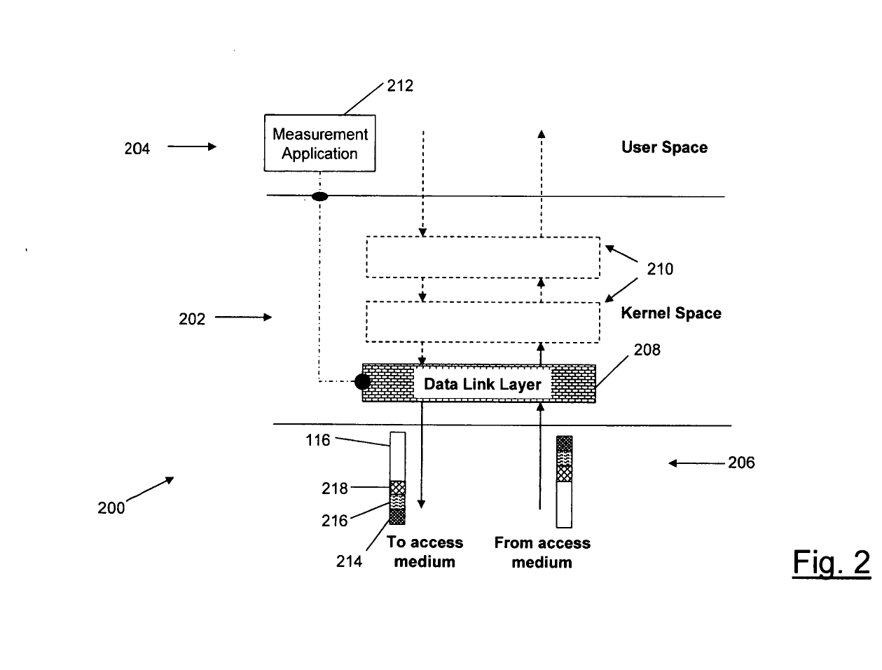

Referring to FIG. 2, the source node 102 comprises a processing resource 200 consisting of, inter alia, at least one microprocessor (not shown), a volatile memory (not shown), for example a Random Access Memory (RAM), a non-volatile memory (not shown), for example a Read Only Memory (ROM). The processing resource 200 supports a kernel space 202, a part of the processing resource 200 reserved for supporting a protocol stack. In this example, the protocol stack is implemented according to appropriate layers in the OSI seven-layer Reference Model. Additionally, the processing resource 200 supports a user space 204, a part of the processing resource 200 reserved for the execution of user applications, for example a video streaming server. The processing resource 200 also supports an access medium interface 206, i.e. the Physical layer.

In relation to the protocol stack, the protocol stack comprises, inter alia, a Data Link layer 208, as well as other upper layers 210 and a Physical layer (not shown) below the Data Link layer 208.

Amongst the applications residing in the user space 204, there is a measurement application 212 for injecting measurement packets into the communications network 100. To achieve this task, the measurement application 212 is capable of interfacing with the Data Link layer 208.

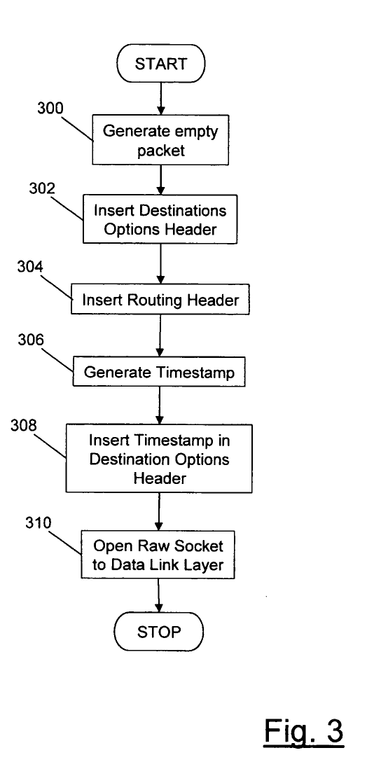

In operation (FIGS. 1, 2 and 3), the measurement application 212 generates (300) an empty IPv6 packet 116 having a packet header 214 containing a source IP address of the source node 102 in a source address field of the packet 116 and a destination IP address of the destination node 114 in a destination address field of the packet 116. The packet 116 is formed as part of a fully-formed Data Link payload. The measurement application 212 then inserts (302) a Destination Options Header 216 into the packet 116 along with an opaque object in the form of a Type Length Value tuple, known as an IPv6 Option. The measurement application 212 also inserts (304) a Routing Header 218 into the packet 116, the routing header 218 containing a routing IP address corresponding to the IP address of the source node 102. The measurement application 212 then generates (306) and inserts (308) a first timestamp, constituting measurement data, into the Option contained within the Destination Options Header 216.

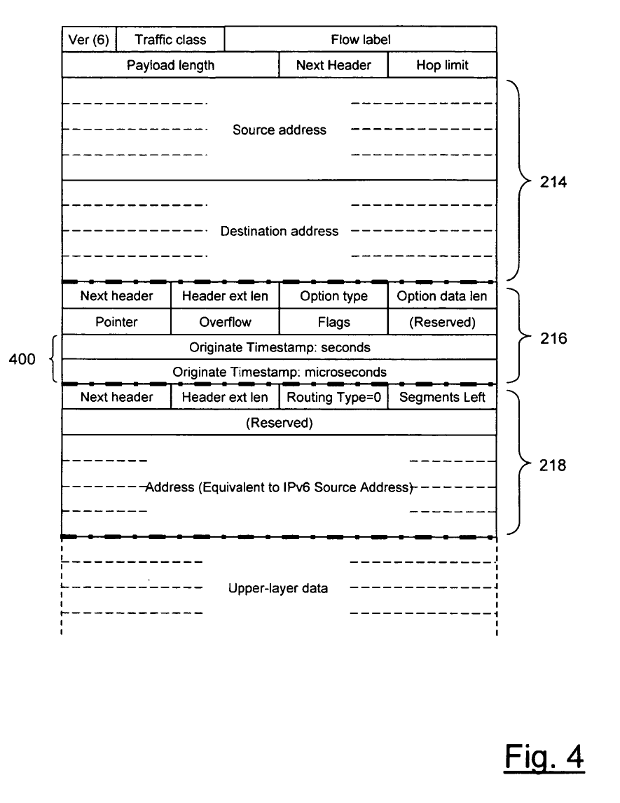

Turning to FIG. 4, the structure of the packet 116 is formed in accordance with the RFC 2460 relating to Destination Options Headers. Destination Options Headers are an example of extension headers, which contain IPv6 options, which are examples of opaque objects. Opaque objects are provided in accordance with extendible schemas supported by the protocol used to form the protocol data unit, in this example the packet 116.

After insertion of the timestamp into the Destination Options Header 216 of the packet 116, the measurement application 212 opens a raw socket to the Data Link layer 208 and inserts the fully-formed Data Link payload into the Data Link layer 208. Thereafter, the packet 116 is forwarded to the destination node 114, albeit via a number of the intermediate nodes, selected in accordance with routing tables (not shown) of the number of the intermediate nodes, between the source node 102 and the destination node 114.

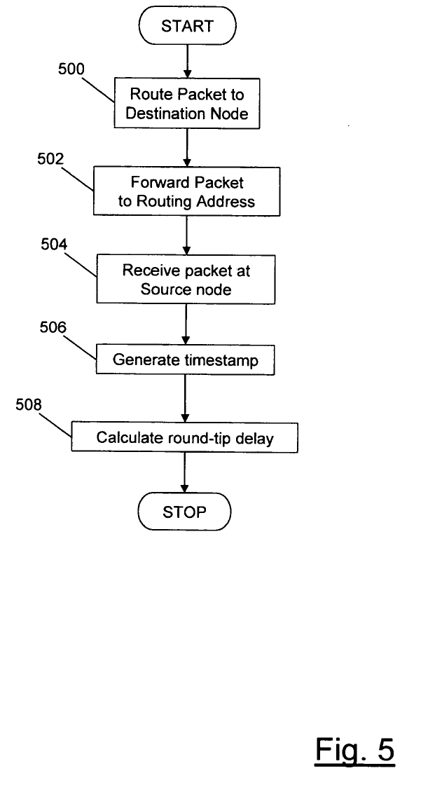

Referring to FIG. 5 and as described above, the packet 116 is routed (500) to the destination node 114, at which point the destination node 114 swaps the destination IP address in the destination address field of the packet 116 with the routing IP address stored in the Routing Header 218.of the packet 116. The packet 116 is then forwarded (502) back to the source node 102 by the destination node 114 using the routing IP address in accordance with normal IPv6 supported behaviour of the destination node 114. Subsequently, the packet 116 is received (504) by the source node 116, whereupon a second timestamp is generated (506) by the measurement application 212 in response to detection by the measurement application 212 of the Type of the Option previously inserted into the Destination Options Header 216. The measurement application 212 then extracts the first timestamp from the packet 116 and subtracts the value of the first timestamp from the second timestamp generated upon receipt of the packet 116 in order to calculate (508) a round-trip time, an example of a delay time metric.

In another embodiment, in order to achieve the following functionality, the destination node 114 has another processing resource (not shown) supporting an operating system, for example, Linux, that supports a dynamically loadable kernel code that interfaces with respective points in a kernel protocol stack via appropriately located kernel “hooks” that are pre-compiled into the kernel protocol stack or pre-exist in the kernel, for example those of Netfilter, at the network layer or below. Consequently, the destination node 114 can provide modified, and in this example extended, functionality over functionality normally provided by nodes supporting the IPv6 protocol. Alternatively, the modifications and extensions can be achieved by applying a patch to source code of the kernel protocol stack and then recompiling the kernel. However, whilst Linux-based kernels can be employed, it is possible to use dynamically linkable libraries, available for other kernels such as various versions of Microsoft® Windows™, to achieve the same functionality as will now be described.

The kernel hooks constitute instrumentation of the destination node 114, causing the destination node 114 to generate a third timestamp upon receipt of the packet 116 and insert the third timestamp 600 into the Destination Options Header 216 of the packet 116. Additionally or alternatively, the destination node 114 also generates a fourth timestamp 602 immediately prior to forwarding the packet 116 back to the source node 102, the fourth timestamp also being inserted into the Destination Options Header 216 of the packet 116.

Upon receipt of the packet 116 at the source node 102, the second timestamp is generated (506) as described above and any combination of the first timestamp 400, the second timestamp, the third timestamp 600 and the fourth timestamp 602 are used to calculate a delay time metric. For example, the first and third timestamps 400, 600 can be used to calculate a one-way delay time between the source node 102 and the destination node 114 in the outward bound direction, or a one-way delay time can be calculated but between the source node 102 and the destination node 114 using the fourth timestamp 602 and the second timestamp in respect of the return direction. Additionally, or alternatively, the two one-way delay time measurements can be used to calculate a round-trip time that is exclusive of any delays caused within the destination node 114.

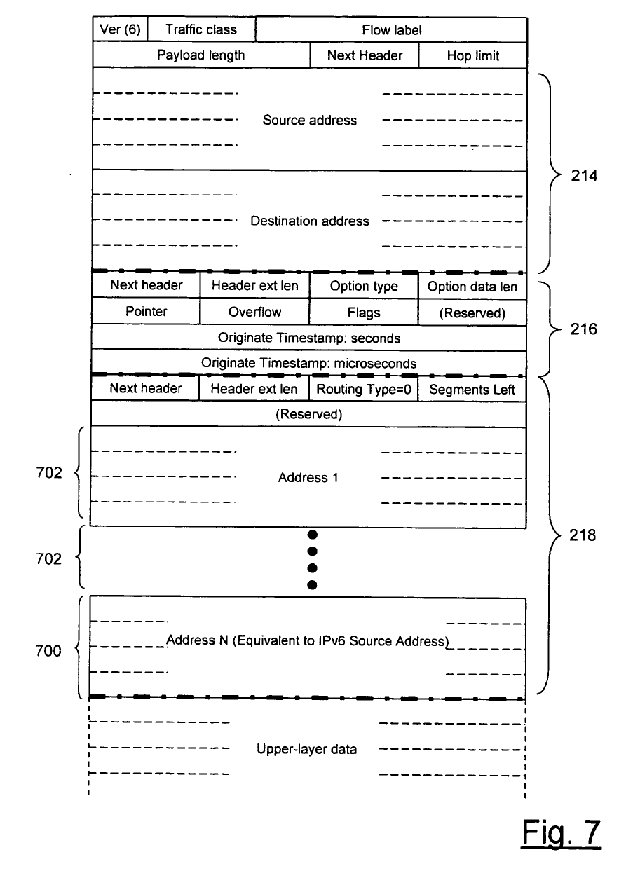

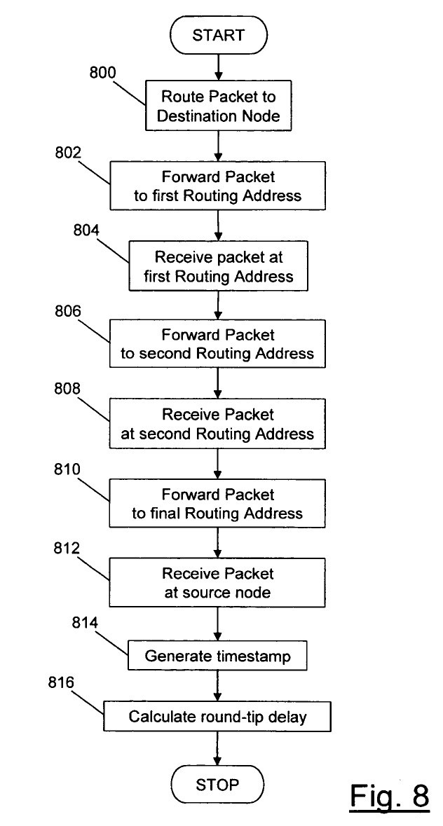

In a third embodiment (FIGS. 7 and 8), the technique of the first embodiment is modified so that, in addition to inserting (304) a Routing Header 218 into the packet 116, the routing header 218 containing the routing IP address corresponding to the IP address of the source node 102, the measurement application 212 also inserts a number of intermediate IP addresses into the Routing Header 218. The routing IP address 700 (FIG. 7) becomes a final IP address in the Routing Header 218. The number of intermediate IP addresses 702 respectively correspond to a number of the intermediate nodes 104, 106, 108, 110, 112.

In this example, the measurement application 212 selects the IP addresses of the fifth intermediate node 112 and the second intermediate node 106. Consequently, in operation (FIG. 8), in a like manner to that described above in relation to the first embodiment, the packet 116 is forwarded (800) to the destination node 114, albeit via a number of the intermediate nodes, selected in accordance with routing tables (not shown) of the number of the intermediate nodes, between the source node 102 and the destination node 114. Thereafter, the destination node 114 forwards (802) the packet 116 to a first intermediate IP address listed in the Routing Header 218 of the packet 116. Upon receipt (804) of the packet 116 at the fifth intermediate node 112 corresponding to the first intermediate IP address, the fifth intermediate node 112 forwards (806) the packet 116 to a second intermediate IP address listed in the Routing Header 218 of the packet 116. Upon receipt (808) of the packet 116 at the second intermediate node 106 corresponding to the second intermediate IP address, the second intermediate node 106 forwards (810) the packet 116 to the final IP address 700 listed in the Routing Header 218 of the packet 116. Consequently, the packet 116 is finally received (812) at the source node 102 corresponding to the final IP address 700, whereupon the source node 102 generates the second timestamp (814) in the same way as already described above in relation to the first embodiment. The measurement application 212 then extracts the first timestamp from the packet 116 and subtracts the value of the first timestamp from the second timestamp generated upon receipt of the packet 116 in order to calculate (816) the round-trip time. However, the round-trip time calculated in this embodiment is in respect of a specific round-trip path selected by the measurement application 212.

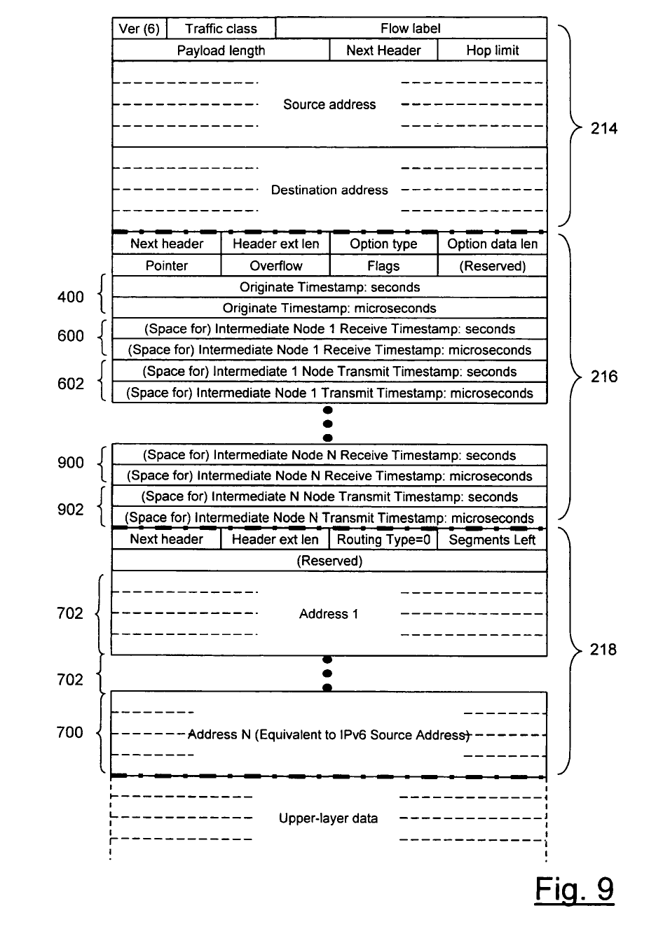

In a fourth embodiment (FIG. 9), the technique of the third embodiment is modified in a similar manner to that described above in relation to the second embodiment.

In addition to instrumenting the destination node 114 to be able to add the third and fourth timestamps 600, 602 to the Destination Options Header 216 of the packet 116, the intermediate nodes 104, 106, 108, 110, 112 are also instrumented in the same way as the destination node 114. Consequently, when the packet 116 is received (804) at the fifth intermediate node 112, a fifth timestamp 900 is generated and added to the Destination Options Header 216 of the packet 116. Additionally, or alternatively, immediately prior to forwarding (806) the packet 116 to the second intermediate node 106, a sixth timestamp 902 is generated and added to the Destination Options Header 216 of the packet 116.

Similarly, at the second intermediate node 106, upon receipt (808) of the packet 116, a seventh timestamp (not shown) is generated and added to the Destination Options Header 216 of the packet 116. Additionally, or alternatively, immediately prior to forwarding (810) the packet 116 back to the source node 102, an eighth timestamp (not shown) is generated and added to the Destination Options Header 216 of the packet 116. At the source node 102, the second timestamp is generated upon receipt of the packet 116 as previously described.

Usefully, the packet 116 carries pairs of timestamps in respect of each hop between routers specified in the Routing Header 218 of the packet 116, as well as in respect of a time of arrival at the destination node 114 and a time of departure from the destination node 114. Any combination of this timestamp data can be used to calculate a number of different delay time metrics. For example, and as described above in relation to the second embodiment, the first and third timestamps 400, 600 can be used to calculate a one-way delay time between the source node 102 and the destination node 114 in the outward bound direction, or a one-way delay time can be calculated but between the source node 102 and the destination node 114 using the fourth timestamp 602 and the second timestamp in respect of the return direction. Additionally, or alternatively, the two one-way delay time measurements can be used to calculate a round-trip time that is exclusive of any delays caused within the destination node 114.

However, in addition to these time delay metrics, the measurement application 212 can also calculate constituent elements of the total delay time calculated by subtracting appropriate timestamps from those collected by the packet 116, i.e. the first, third, fourth, fifth, sixth, seventh and eighth timestamps, and/or the second timestamp.

Although the above embodiment has been described in the context of all the intermediate nodes being instrumented to supplement the Destination Options Header 216 of the packet 116 with measurement data, it should be appreciated that only those nodes from which measurement data is required need be instrumented. Indeed, in some communication networks not all nodes will be instrumented in this way and so timestamps will not always be added to the Destination Options Header 216 for all hops specified in the Routing Header 218 of the packet 116.

In the above embodiments, raw sockets are opened in order to inject the packet 116 into the network 100. However, in another embodiment, the instrumenting technique applied above in relation to the destination node 114 can be used to instrument the source node 102 so as to comprise an interception module that resides in the kernel space.

The measurement application 212 generates an IPv6 packet without an appropriate Destination Option for collecting measurement data or Routing Header, the IPv6 packet being subsequently passed down through the protocol stack. Alternatively, an application residing in the user space and that supports generation of traffic, for example the video server already mentioned above, can be adapted to generate the IPv6 packet without the Routing Header and appropriate Destination Option. The interception module can then intercept the IPv6 packet formed by either of the above techniques and add the Routing Header and the appropriate Destination Option in order to collect measurement data and follow the round-trip path mentioned above in relation to the previous embodiments.

The interception module is either pre-configured or dynamically configurable, for example from the user space. In this respect, the configuration comprises setting one or more filters to allow the interception module to identify IPv6 packets conforming to pre-determined criteria, for example packet length, source and destination IPv6 addresses, and/or payload protocol type. The filter can also be governed by a sampling scheme.

Although the above embodiments have been described in the context of IPv6, the skilled person will appreciate that the above described techniques can be applied in the context of other communications protocols that support extendible schemas and source-based routing.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of measuring a delay time metric in relation to a round-trip path in a communications network, the method comprising:
generating a protocol data unit in accordance with a data structure definition of a communications protocol supporting an extendible schema, the protocol data unit comprising an opaque object conforming to the extendible schema;
providing the protocol data unit with a routing address corresponding to a source node to cause the protocol data unit, when sent, to follow the round-trip path from the source node back to the source node via a destination node;
sending the protocol data unit from the source node to the destination node;
receiving the protocol data unit at the destination node;
forwarding the protocol data unit from the destination node to the routing address; wherein
measurement data is recorded in the opaque object in respect of at least one network node on the round-trip path; and
at least part of the measurement data contained in the opaque object is used to calculate the delay time metric.

2. A method as claimed in claim 1, wherein the at least one network node comprises the source node, the delay time metric being a round-trip time metric.

3. A method as claimed in claim 1, wherein the measurement data comprises:
first measurement data indicative of a time of departure of the protocol data unit from the source node.

4. A method as claimed in claim 3, wherein the delay time metric is calculated from the measurement data contained in the opaque object and second measurement data indicative of a time of receipt of the protocol data unit by the source node.

5. A method as claimed in claim 3, wherein the measurement data comprises:
second measurement data indicative of a time of receipt of the protocol data unit by the source node.

6. A method as claimed in claim 1, further comprising:
providing the protocol data unit with at least one further routing address in addition to the routing address provided prior to sending the protocol data unit to the destination node.

7. A method as claimed in claim 1, wherein the routing address is a final routing address.

8. A method as claimed in claim 4, further comprising:
generating third measurement data at the destination node, the third measurement data being indicative of a time of receipt of the protocol data unit at the destination node; and
supplementing the opaque object with the third measurement data.

9. A method as claimed in claim 4, further comprising:
generating fourth measurement data at the destination node, the fourth measurement data being indicative of a time of transmitting the protocol data unit from the destination node; and
supplementing the opaque object with the fourth measurement data.

10. A method as claimed in claim 6, wherein
the at least one further routing address corresponds to an intermediate node; and the method further comprises:
receiving the protocol data unit at the intermediate node;
generating fifth measurement data indicative of a time of receipt of the protocol data unit at the intermediate node; and
supplementing the opaque object with the fifth measurement data.

11. A method as claimed in claim 6, wherein
the at least one further routing address corresponds to an intermediate node; and the method further comprises:
receiving the protocol data unit at the intermediate node;
generating sixth measurement data indicative of a time of transmitting the protocol data unit from the intermediate node; and
supplementing the opaque object with the sixth measurement data.

12. A method as claimed in claim 1, further comprising: setting a traffic class field of the protocol data unit.

13. A method as claimed in claim 1, further comprising: setting a flow label field of the protocol data unit.

14. A method as claimed in claim 1, wherein the protocol data unit is a IPv6 packet.

15. A method as claimed in claim 1, wherein the measurement data is timestamp data.

16. A computer program code element comprising computer program code means to make a computer execute the method as claimed claim 1.

17. A computer program code element as claimed in claim 6, embodied on a computer readable medium.

18. A network node apparatus for generating a monitoring protocol data unit, the apparatus comprising:
a processing resource arranged to generate, when in use, a protocol data unit in accordance with a data structure definition of a communications protocol supporting an extendible schema, the protocol data unit comprising an opaque object conforming to the extendible schema; wherein
the protocol data unit comprises a routing address corresponding to the network node apparatus for causing the protocol data unit, when sent, to follow a round-trip path from the network node back to the network node via a destination node; and
the processing resource is further arranged to send, when in use, the protocol data unit from the network node to the destination node, the opaque object comprising first measurement data indicative of a departure time of the protocol data unit from the network node.

19. An apparatus as claimed in claim 18, wherein the processing resource is arranged to generate, when in use, second measurement data in response to receipt of the protocol data unit by the network node, and using the first and second measurement data to calculate a round-trip time metric.

20. A measurement system for a communications network, the system comprising:
a source node arranged to generate, when in use, a protocol data unit in accordance with a data structure definition of a communications protocol supporting an extendible schema, the protocol data unit comprising an opaque object conforming to the extendible schema, and including a routing address corresponding to the source node to cause the protocol data unit, when sent, to follow a round-trip path from the source node back to the source node;
a destination node arranged to receive, when in use, the protocol data unit sent, when in use, from the source node, the destination node being further arranged to forward, when in use, the protocol data unit to the routing address; wherein
measurement data is recorded in the opaque object in respect of at least one network node on the round-trip path; and
at least part of the measurement data contained in the opaque object is used to calculate a delay time metric.

21. A use of a protocol data unit to follow a round-trip path and collect measurement data from at least one node on the round-trip path, the protocol data unit having been formed in accordance with a data structure definition of a communications protocol supporting an extendible schema, the protocol data unit comprising an opaque object conforming to the extendible schema and the opaque object comprising the measurement data.
